(19) United States
(12) Patent Application Publication
(10) Pub. No.: US 2014/0238777 A1
(43) Pub. Date: Aug. 28, 2014

(54) LADDER COVER APPARATUS AND METHOD OF SETTING UP A LADDER

(71) Applicant: David Cary Adair, Kansas City, MO (US)

(72) Inventor: David Cary Adair, Kansas City, MO (US)

(21) Appl. No.: 14/189,542

(22) Filed: Feb. 25, 2014

Related U.S. Application Data
(60) Provisional application No. 61/768,966, filed on Feb. 25, 2013.

(51) Int. Cl. E06C 7/46

(52) U.S. Cl. CPC E06C 7/46
USPC 182/108; 29/426.2

(57) ABSTRACT

A ladder cover constructed from a thick cloth material, such as cotton, aligned in a generally straight orientation with no bends or turns. The cover is made up of three general regions: a body portion which is large enough to encompass most or all ladder legs; a base section for elastically securing the cover to a ladder leg; and a gripping section generally comprised of a polyvinyl chloride (PVC) coating applied to the capped end of the body portion of the cover. The cover is applied to the ends of a ladder to protect walls and floor surfaces while increasing the grip of the ladder legs against those surfaces. The cover is easily washable, storable, and reusable.

### CROSS-REFERENCE TO RELATED APPLICATION

This application claims priority in U.S. Provisional Patent Application No. 61/768,966, filed Feb. 25, 2013, which is incorporated herein by reference.

### BACKGROUND OF THE INVENTION

1. Field of the Invention

The present invention relates generally to a ladder cover and more specifically to a cover for use with any ladder type which protects the floor or wall surface of a structure from the ladder's frame while providing a high-friction interface between the ladder and a wall and/or flooring surface.

2. Description of the Related Art

Ladder covers are used to protect walls and floors from damage. Ladders are often leaned against walls and/or placed on finished floors and so it is important to protect these surfaces. Other surfaces may also need protecting, such as bathtubs, or any other surface where a ladder may be placed on or against.

Many industries heavily rely upon ladders, such as interior and exterior painters, electricians, and decorators. As such, it is important that ladder covers be highly durable and, ideally, easily cleanable and reusable.

Existing ladder covers are made of heavy plastic, rubber, or similar materials. These are often shaped to fit common ladder shapes, but they do not conform to all ladder shapes and are therefore not universal covers. Additionally, the material choice makes it difficult to clean these covers. Further, the relatively rigid material does not create a sufficiently better surface for protecting walls, and some materials, such as hard plastic, would not provide a sufficiently better surface for preventing slippage on a floor surface.

What is needed is a ladder cover that is universal to all ladder feet, is easily cleanable, provides a better grip against wall and floor surfaces, and is of a soft material to protect walls and floor from damage from the cover itself.

Heretofore there has not been available a ladder cover with the advantages and features of the present invention.

### SUMMARY OF THE INVENTION

In the practice of the present invention, a preferred embodiment ladder cover comprises a thick cotton “sock” aligned in a generally straight orientation. The cover is made up of three general regions: a body portion which is large enough to encompass most or all ladder legs; a base section for elastically securing the cover to a ladder leg; and a gripping section generally comprised of a polyvinyl chloride (PVC) coating applied to the capped end of the body portion of the cover.

### BRIEF DESCRIPTION OF THE DRAWINGS

The accompanying drawings illustrate the principles of the present invention and an exemplary embodiment thereof.

FIG. 1 is an elevational view of an embodiment of the present invention.

FIG. 2 is a top plan view thereof.

FIG. 3 is a bottom plan view thereof.

FIG. 4 is an elevational view diagramming how an embodiment of the present invention is used when a ladder element is placed against a wall.

FIG. 5 is an elevational view diagramming how an embodiment of the present invention is used when a ladder element is placed on the feet of an A-frame ladder placed on a floor.

FIG. 6 is a detailed elevational view taken about the circle of FIG. 5.

FIG. 7 is an elevational view of an alternative embodiment of the present invention featuring an alternative gripping portion.

FIG. 8 is an elevational view of an alternative embodiment of the present invention featuring an alternative gripping portion.

### DETAILED DESCRIPTION OF THE PREFERRED EMBODIMENT

### I. Introduction, Environment, and Preferred Embodiment

As required, detailed aspects of the present invention are disclosed herein, however, it is to be understood that the disclosed aspects are merely exemplary of the invention, which may be embodied in various forms. Therefore, specific structural and functional details disclosed herein are not to be interpreted as limiting, but merely as a basis for the claims and as a representative basis for teaching one skilled in the art how to variously employ the present invention in virtually any appropriately detailed structure.

Certain terminology will be used in the following description for convenience in reference only and will not be limiting. For example, up, down, front, back, right and left refer to the invention as orientated in the view being referred to. The words, “inwardly” and “outwardly” refer to directions toward and away from, respectively, the geometric center of the aspect being described and designated parts thereof. Forwardly and rearwardly are generally in reference to the direction of travel, if appropriate. Said terminology will include the words specifically mentioned, derivatives thereof and words of similar meaning.

A typical embodiment of the present invention would be used in a typical building environment. A ladder, such as a straight ladder or an A-frame ladder, is equipped with an embodiment of the present invention, wherein a ladder cover is placed between a leg of the ladder and a wall surface and/or a floor surface.

### II. Preferred Embodiment Ladder Cover 2

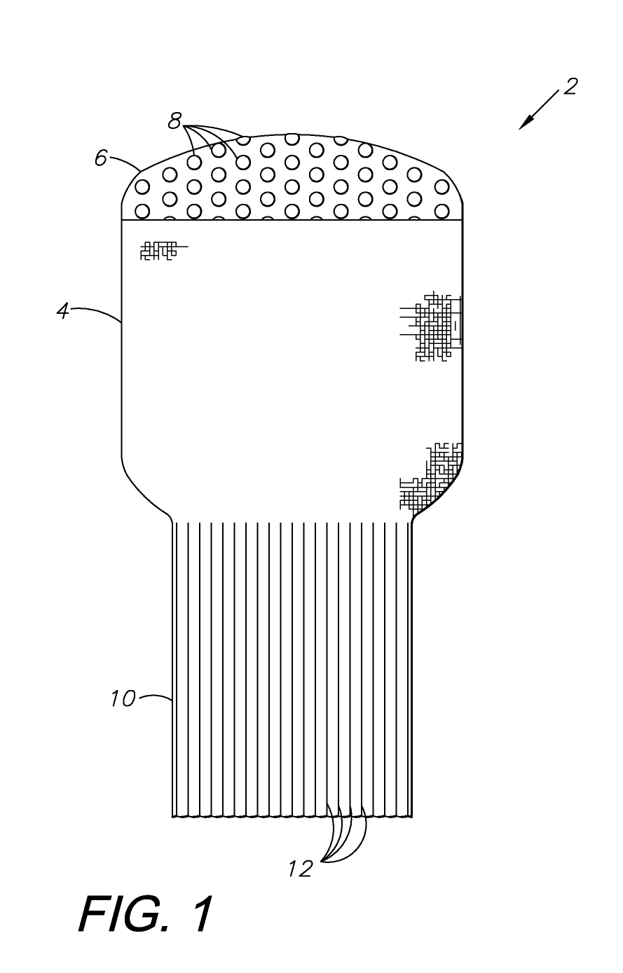

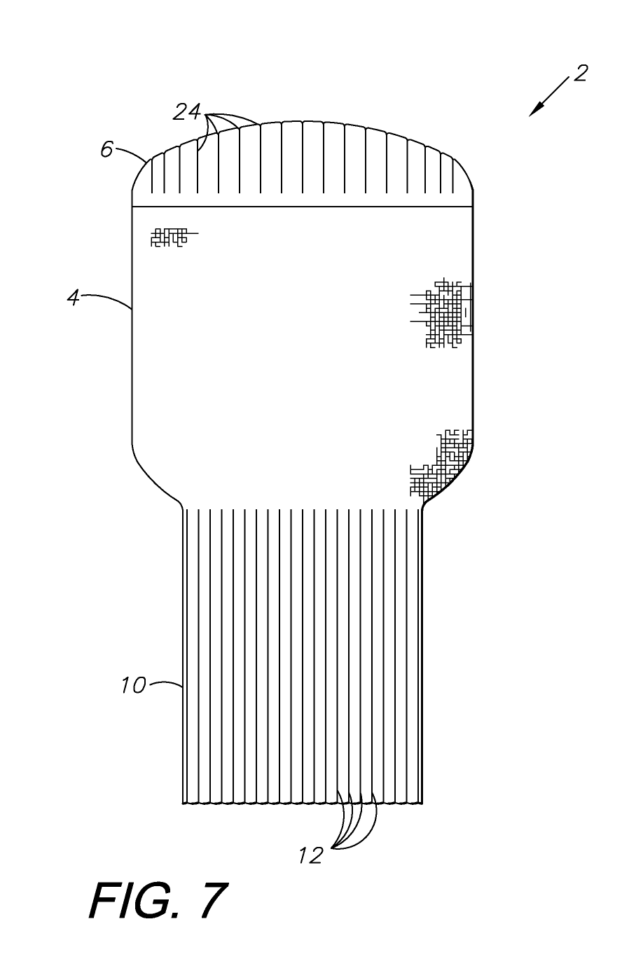

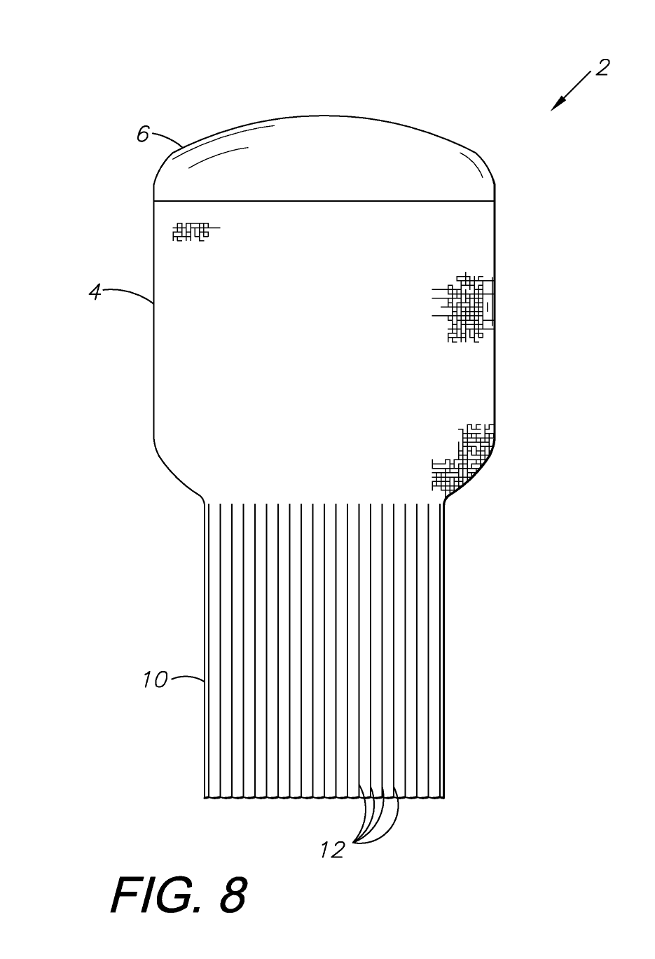

FIG. 1 demonstrates an embodiment ladder cover 2. The embodiment shown in FIG. 1 includes three separate portions to the cover: a body portion 4 comprised of a thick fabric material, such as cotton; an elastic base portion 10 which adapts to the size of, and grips onto, a ladder leg; and a gripping portion 6 which provides a high-friction gripping surface against floors or walls. The embodiment shown in FIG. 1 features a number of PVC “dots” or “nubs” 8 which provide the gripping element. FIG. 7 shows an alternative embodiment where the gripping portion 6 comprises a dipped portion of the body 4 featuring a number of ridges. FIG. 8 shows an alternative embodiment where the gripping portion 6 is simply a dipped end of the body 4 into a PVC or similar compound. The entire surface of the embodiment shown in FIG. 8 produces a high-friction gripping surface.

The elastic base portion 10 as shown in FIG. 1 includes numerous vertical elasticized bands 12. These bands act to compress the materials between the bands around the leg of a ladder. These bands do not necessarily have to be vertically oriented. Instead, the bands could be circumferentially wrapped about the base portion 10, or the base portion 10 could be comprised of one single large elasticized band. Similarly, the elasticized base portion 10 could continue through the body 4, such that the entire cover 2 is elasticized.

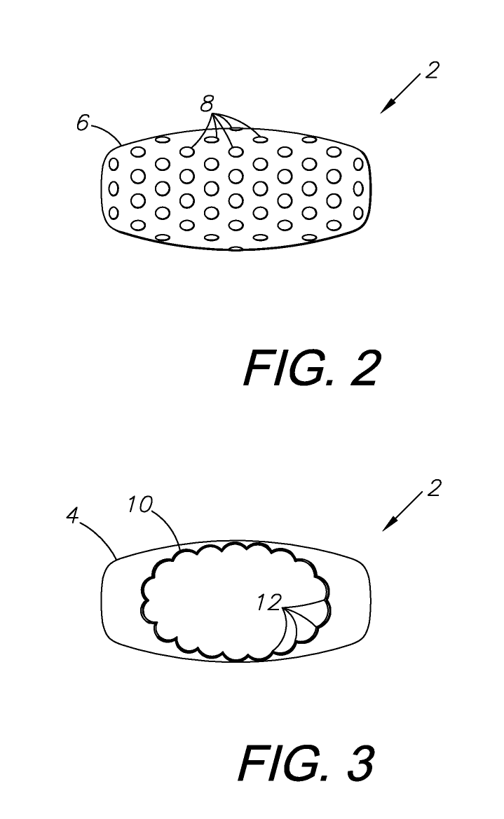

FIG. 2 shows a top-down view of the cover, and FIG. 3 shows a bottom plan view of the same. In FIG. 3, it can be seen how the elasticized bands 12 deform the material of the base portion 10 such that it would grip itself around an object, such as a ladder leg.

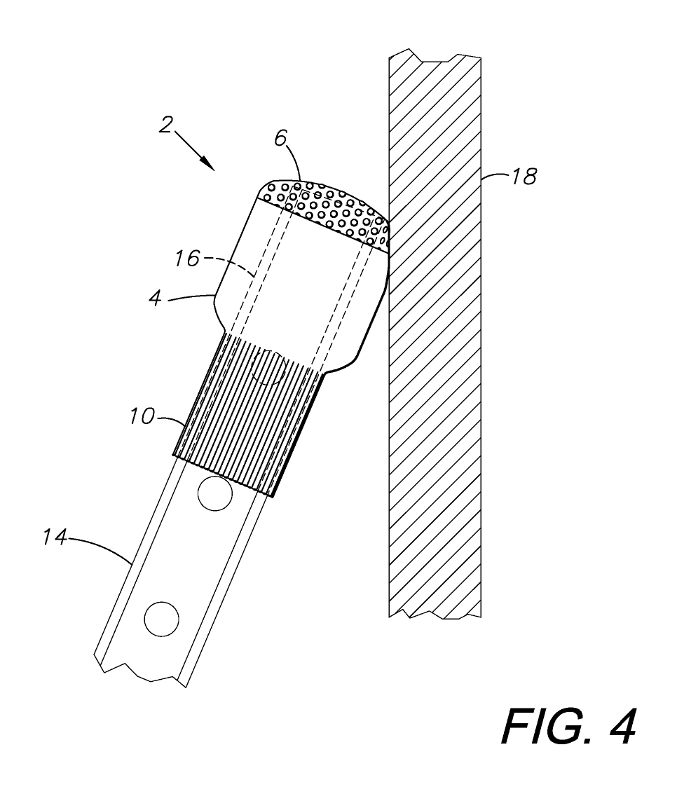

FIG. 4 shows how a typical cover 2 would be applied to the top portion 16 of a straight ladder 14 being leaned up against a wall 18. The gripping portion 6 of the cover 2 provides a non-slip surface against the wall, preventing the ladder from accidentally slipping down the wall 18. The body 4 provides cushioning between the ladder end 16 and the wall 18 to prevent scratching of paint or other structural damage. The base portion 10 of the cover 2 hugs the upper leg of the ladder.

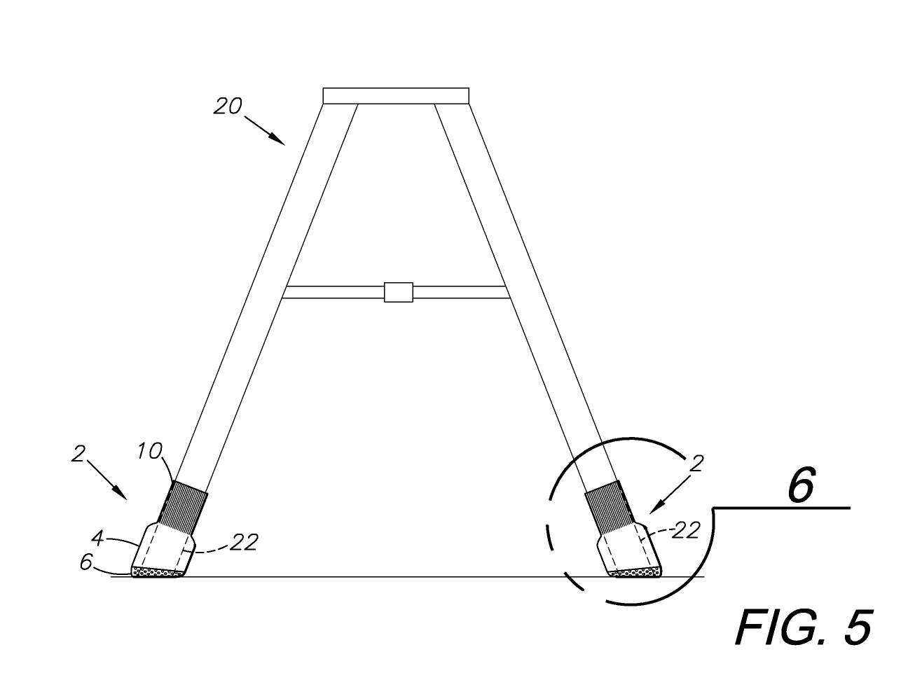

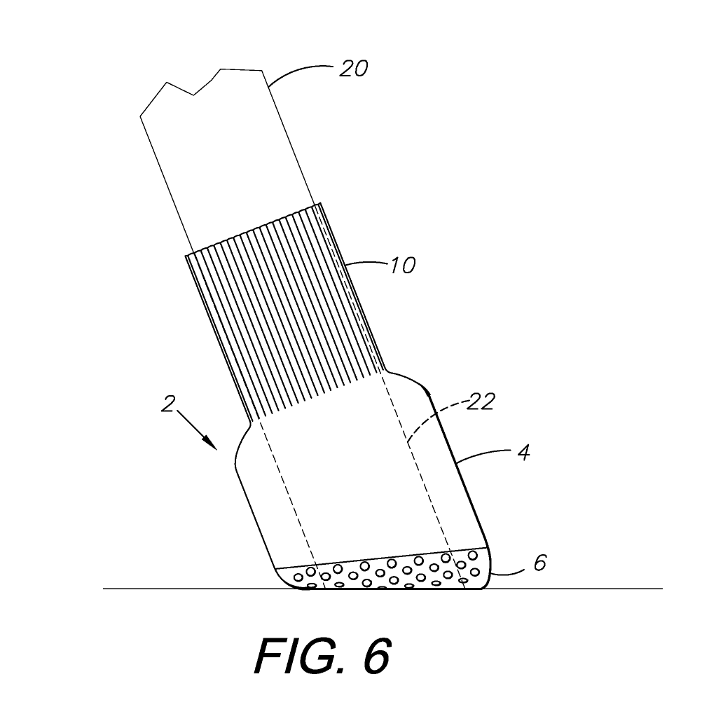

Similarly, FIG. 5 shows a ladder cover 2 being applied to the feet of an A-frame ladder 20. It should be noted that the feet of the straight ladder 14 shown in FIG. 4 could also include covers 2. In FIG. 5, the covers are placed on each of the four ends 22 of the A-frame ladder 20. The gripping portion 6 of the covers 2 contact the floor, preventing the ends of the ladders from scratching the floor while simultaneously increasing the grip against the floor so that the ladder will not accidentally slip. FIG. 6 shows this interface in more detail.

FIG. 7 illustrates a nearly identical cover 2 wherein the gripping portion 6 features a number of gripping ridges 24 rather than the dots or nubs 8. Similarly, FIG. 8 shows an arrangement of the cover 2 where the gripping portion 6 entirely coats the top of the body 4 with a PVC surface, which in testing has produced the most superior results.

Because the body 4, base portion 10, and the material located under the coating of the gripping portion 6 are all made of a cloth material such as cotton, the cover 2 is easily washable after use. It can be thrown into a laundry machine along with rags and work clothing and washed in a typical fashion. The PVC coating is unaffected by such cleaning.

Similarly, because the entire cover is made of a foldable, stretchable cloth, the cover 2 will fit over all ladder legs typically used in the field, and can be easily stored for reuse. It is so compact in storage that the user could place them into a pocket of their work pants before applying the covers to a ladder or after removing them from the ladder.

It is to be understood that while certain aspects of the disclosed subject matter have been shown and described, the disclosed subject matter is not limited thereto and may include various other embodiments and aspects.

Having thus described the invention, what is claimed as new and desired to be secured by Letters Patent is:

1. A ladder cover for covering a portion of a ladder to prevent damage to other surfaces, the ladder cover comprising:
a body portion including an upper end and a lower end;
an elasticized base portion comprising a plurality of elasticized bands, said elasticized base portion affixed to the lower end of said body portion;
a gripping portion comprising a coating applied to the upper end of the body portion, said gripping portion affixed to the upper end of said body portion; and
said elasticized base portion including an opening for receiving the end of a ladder leg.

2. The ladder cover of claim 1, wherein said body portion comprises cotton.

3. The ladder cover of claim 1, wherein the coating of said gripping portion comprises a plurality of polyvinyl chloride (PVC) dots dotting a cotton surface.

4. The ladder cover of claim 1, wherein the coating of said gripping portion comprises a cotton surface dipped in a PVC coating.

5. The ladder cover of claim 4, wherein the coating of said gripping portion further comprises a plurality of ridges formed by said PVC coating.

6. The ladder cover of claim 1, wherein said elasticized bands are vertically oriented along said base portion.

7. The ladder cover of claim 1, wherein said elasticized bands are circumferentially oriented around said base portion.

8. A ladder cover for covering a portion of a ladder to prevent damage to other surfaces, the ladder cover comprising:
a body portion including an upper end and a lower end, said body portion comprising a soft cushion body including cotton;
said body portion lower end comprising an elasticized base portion including a plurality of vertically-oriented elasticized bands;
said body portion upper end comprising a gripping portion, wherein said gripping portion is formed by coating said body portion upper end with a poly-vinyl chloride (PVC) coating; and
said elasticized base portion including an opening for receiving the end of a ladder leg

9. A method of using a ladder cover with a ladder, the method comprising the steps:
sliding a ladder cover onto a leg of a ladder, said ladder cover comprising: a body portion comprised of a soft cushion material and having an upper end and a lower end; an elasticized base portion affixed to the lower end of said body portion; and a gripping portion comprising a coating applied to the upper end of the body portion;
wherein said elasticized base portion includes a plurality of elasticized bands;
gripping said leg with said elasticized base portion;
placing the ladder against a surface such that said ladder cover forms a non-slip, soft-cushioned barrier between said leg and said surface;
removing said ladder from said surface; and
removing said ladder cover from said leg.

10. The method of claim 9, further comprising the steps:
placing said ladder cover into a laundry washing machine; and
cleaning said ladder cover with said laundry washing machine.

11. The method of claim 9, wherein said surface comprises a member of a group comprising: a floor, an interior wall, and an exterior wall.

12. The method of claim 9, wherein said body portion comprises cotton.

13. The method of claim 9, wherein the coating of said gripping portion comprises a plurality of polyvinyl chloride (PVC) dots dotting a cotton surface.

14. The method of claim 9, wherein the coating of said gripping portion comprises a cotton surface dipped in a PVC coating.

15. The method of claim 14, wherein the coating of said gripping portion further comprises a plurality of ridges formed by said PVC coating.

16. The method of claim 9, wherein said elasticized bands are vertically oriented along said base portion.

17. The method of claim 9, wherein said elasticized bands are circumferentially oriented around said base portion.
